(19) United States
(12) Patent Application Publication
(10) Pub. No.: US 2006/0000963 A1
(43) Pub. Date: Jan. 5, 2006

(54) Light source calibration

(76) Inventors: Kee Yean Ng, Penang (MY); Heng Yow Cheng, Penang (MY); Joon Chock Lee, Sarawak (MY)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/880,949

(22) Filed: Jun. 30, 2004

(51) Int. Cl. G01J 1/32

(52) U.S. Cl. 250/205

(57) ABSTRACT

A light source is calibrated and operated. During calibration of the light source, calibration light is provided from a calibration light source. The calibration light is detected. A representation of the detected calibration light is stored. During operation of the light source, light is generated by the light source. The light generated by the light source is detected. The detected light generated by the light source is compared with the stored representation of the detected calibration light to generate information used to control color of the light generated by the light source.

### BACKGROUND

The emergence of high brightness light emitting diodes (LEDs) in a wide range of colors has extended the use of LEDs for applications such as backlighting and illumination. LEDs have higher light conversion efficiencies and longer lifetimes than traditional incandescent light fixtures. However, individual LEDs produce light in a relatively narrow spectral band. Therefore, multiple LEDs are used to produce light with a desired color mixture.

A combination of red, green and blue LEDs can be used to generate millions of color combinations within the boundaries defined by the colors of the LEDs used. For example, if the color coordinates of the red, green and blue LEDs are plotted on the 1931 CIE color space, they will define the three apexes of a color triangle. In theory, all colors within the color triangle can be produced by a suitable combination of light from the red, green and blue LEDs.

One limitation of the use of LEDs as a light source is that the optical performance of LEDs changes with drive conditions, temperature and aging of the LEDs. Therefore, LED based light sources often show a drift in produced color under different environmental factors such as when there are significant swings in temperature changes or when the LEDs age. The resulting color drift or change can be detrimental in some lighting applications such as in backlighting and illumination where the color must be maintained at a fixed point.

A feedback system can be employed to maintain color. For example, a photodiode with an appropriate filter can measure the light that is generated from an LED of a particular color. The output signal of the photodiode is compared to a reference value thereby generating an error signal which is be used to adjust the light output of the LED. See, for example, U.S. Pat. No. 6,507,159 where both the output signals of the photodiode and the reference value are transformed to a standard calorimetric system such as CIE 1931 color space in order to compare the output signals of the photodiodes to the reference value. However, the output signal of the photodiode is usually a voltage while the reference value is an arbitrary numerical value corresponding to a color condition and having a nomenclature in a certain calorimetric standard. Additional implementation difficulties arise with this type of system. For example, the color values of each LED color must be known. Furthermore, the photodiode characteristics have to be considered. Therefore, a calibration process must be performed to determine the transformation matrices of physically measured quantities into some standard calorimetric system. Such measurements require specific expertise and are complex. Depending on the accuracy needed, expensive equipment may be needed to perform this calibration.

Within a 1931 CIE color space, a black body curve represents the color of the spectral radiations emitted by a black body. The spectral radiation emitted by a black body is only dependent on its temperature and accordingly, each point on the black body curves is conveniently assigned a color temperature. These color temperature are also known as the color temperatures of white light. For example, the color temperature of sunlight at noontime is 6500 Kelvin (D65). This is also a color of the cool white fluorescent light. An incandescent bulb, on the other hand, gives warm white and has a color temperature of about 2800K (A).

Color temperature as described by the black body curve is commonly used in the lighting industry for applications such as general illumination, cathode ray tubes, backlighting or lighting of consumer appliances such as TVs. Such applications typically do not require colors other than white. Usually a single white or a number of white colors are all that is needed. However, it is generally desired that a generated white color be stable.

### SUMMARY OF THE INVENTION

In accordance with an embodiment of the present invention, a light source is calibrated and operated. During calibration of the light source, calibration light is provided from a calibration light source. The calibration light is detected. A representation of the detected calibration light is stored. During operation of the light source, light is generated by the light source. The light generated by the light source is detected. The detected light generated by the light source is compared with the stored representation of the detected calibration light to generate information used to control color of the light generated by the light source.

### BRIEF DESCRIPTION OF THE DRAWINGS

FIG. 1 illustrates calibration of an LED lighting system in accordance with an embodiment of the present invention.

FIG. 2 illustrates normal operation of the LED lighting system shown in FIG. 1.

### DESCRIPTION OF THE EMBODIMENT

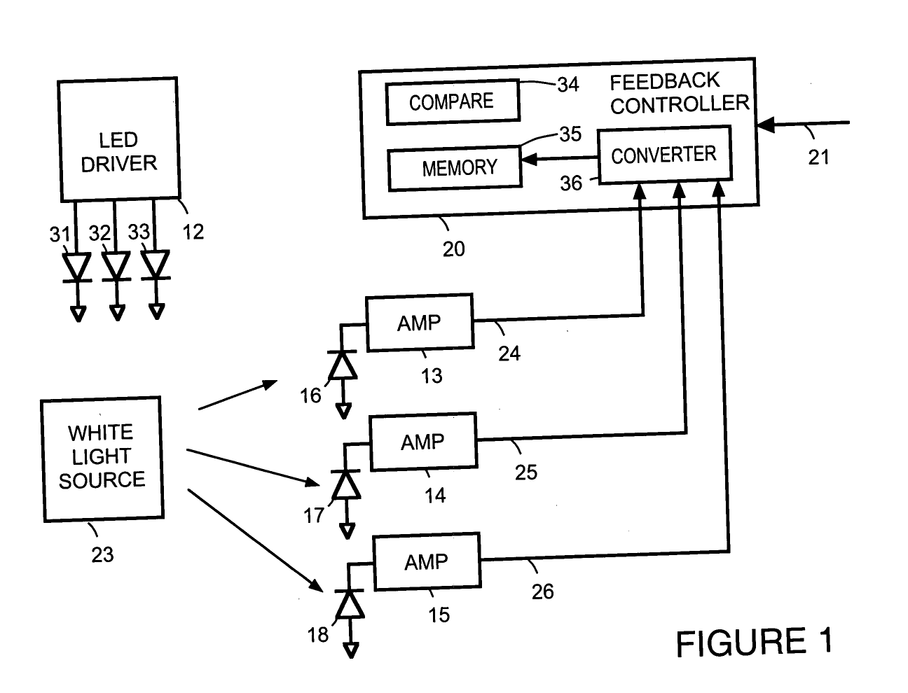

FIG. 1 illustrates calibration of an LED lighting system. A white light source 23 generates a white light of a first desired color temperature. For example, the noon day sun is generally considered to have a color temperature of 6500 Kelvin. A typical color temperature of white light of standard personal computer monitor or a laptop monitor is, for example, 9300 Kelvin. The color temperature of a typical incandescent bulb is, for example, 2800 Kelvin.

A photosensor 16 and an amplifier (AMP) 13 generate a signal 24. Photosensor 16 includes a red color filter. Signal 24 is a signal that indicates the proportional red component of light generated by white light source 23.

A photosensor 17 and an amplifier (AMP) 14 generate a signal 25. Photosensor 17 includes a green color filter. Signal 25 is a signal that indicates the proportional green component of light generated by white light source 23.

A photosensor 18 and an amplifier 15 (AMP) generate a signal 26. Photosensor 18 includes a blue color filter. Signal 26 is a signal that indicates the proportional blue component of light generated by white light source 23.

For example, photosensor 16, photosensor 17 and photosensor 18, with a necessary amplifier and signal conversion circuit, can each output a signal to indicate detected light intensity, for example, a voltage or frequency signal. The type of signal produced determines the type of amplifier and signal conversion circuit that is needed.

A converter 36 within a feedback controller 20 receives the values for signal 24, signal 25 and signal 26, performs, for example if necessary, an analog-to-digital (A/D) conversion on each value and stores the resulting digital values for signal 24, signal 25 and signal 26 in a memory 35. The digital values for signal 24, signal 25 and signal 26 together form an RGB calibration entry for the first desired color temperature of white. For example, memory 35 is implemented using a non-volatile memory technology. Each RGB calibration entry includes color information that contains both the hue information and the brightness information. An important aspect of the color information is the ratio of the color components, that is, the proportions (ratio) of red, green and blue.

The process is repeated for different color temperatures of white. For example, white light source 23 (or another white light source) generates a white light of a second desired color temperature. Photosensor 16 and amplifier 13 generate a new signal 24 for the second desired color temperature of white. Photosensor 17 and amplifier 14 generate a new signal 25 for the second desired color temperature of white. Photosensor 18 and amplifier 15 generate a new signal 26 for the second desired color temperature of white. Converter 36 receives the new values for signal 24, signal 25 and signal 26, performs an analog-to-digital (A/D) conversion on each new value and stores the resulting new digital values for signal 24, signal 25 and signal 26 in memory 35 as an RGB calibration entry for the second desired color temperature of white.

This process can be repeated for as many different colors, color shades or color temperatures as desired. While, above, the calibration was illustrated with color temperatures of white, the same process can be performed for any of the millions (or more) of color combinations within the boundaries defined by the colors detectable by photosensor 16, photosensor 17 and photosensor 18. Once a light of any color is shown upon photosensor 16, photosensor 17 and photosensor 18, an RGB calibration for that light can be stored in memory 35. The RGB calibration values can be stored in the form of a look-up table or converted into a mathematical equation.

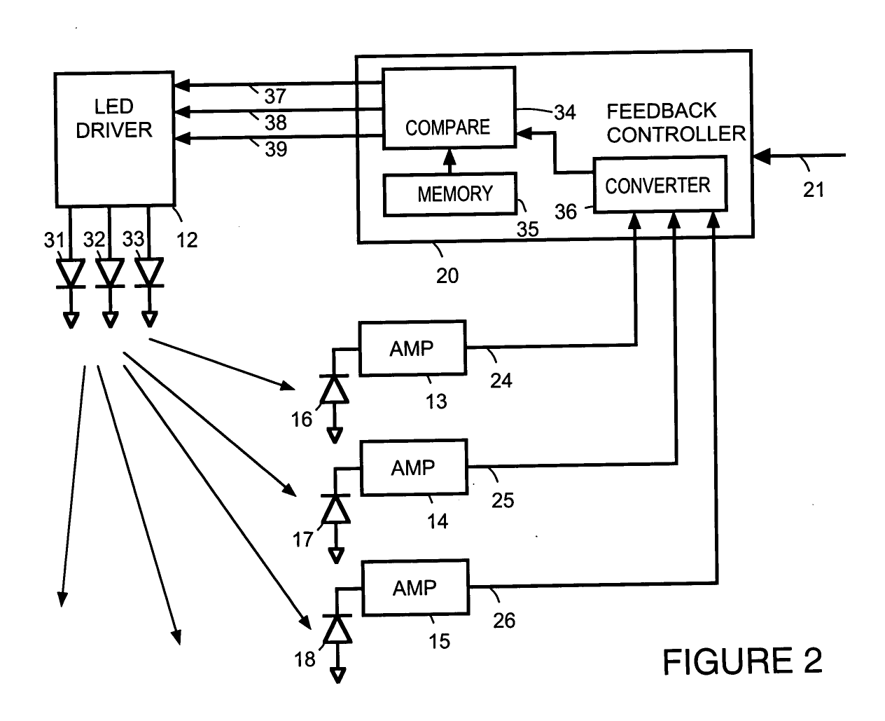

FIG. 2 illustrates normal operation of the LED lighting system shown in FIG. 1. An LED 31 generates red light. An LED 32 generates green light. An LED 33 generates blue light. Intensity of light generated by each of LEDs 31, 32 and 33 is controlled by an LED driver 12. Intensity of light is controlled, for example, by pulse width modulation (PWM) where the duty cycles to each of LEDs 31, 32 and 33 are modulated. Alternatively, intensity of light can be controlled by the amount of current driven through each of LEDs 31, 32 and 33.

An input signal 21 to feedback controller 20 is used to indicate a selected RGB calibration entry stored in memory 35 is to be used to generate light. The resulting light generated by the LED lighting system will be matched with the color of light used to generate the selected RGB calibration entry during calibration of the LED lighting system. For example, feedback controller 20 continuously compares the digital values of drive signals 24, 25 and 26 with the selected RGB calibration entry to generate drive signals 37, 38 and 39 in a close loop control sequence during operation of the LED lighting system. For example, input signal 21 can also include a brightness level control to scale the RGB calibration entry upwards or downwards.

Photosensors 16, 17 and 18 detect the composite generated light and then filter the necessary component for computation. Photosensor 16 and amplifier 13 generate a signal 24 corresponding to the red component of the generated composite light. Photosensor 17 and amplifier 14 generate a signal 25 corresponding to the green component of the composite light. Photosensor 18 and amplifier 15 generate a signal 26 corresponding to the blue component of the generated composite light. Color components (e.g., the red component, the green component and the blue component) include hue and brightness information. Converter 36 receives the values for signal 24, signal 25 and signal 26, performs an A/D conversion and forwards the resulting detected digital values to a compare block 34.

Compare block 34 compares the detected digital values for signal 24, signal 25 and signal 26 with the selected RGB calibration entry. Compare 34 forwards to LED driver 12 a red drive signal 37, a green drive signal 38 and a blue drive signal 39. On the basis of the values of red drive signal 37, green drive signal 38 and blue drive signal 39, LED driver 12 adjusts the intensity of light generated by each of LEDs 31, 32 and 33 until compare block 34 indicates the detected digital values for signal 24, signal 25 and signal 26 are equal to the selected RGB calibration entry or equal to a scaled ratio to the selected RGB calibration entry. At this point, the resulting light generated by the LED lighting system will be matched with the color of light used to generate the selected RGB calibration entry during calibration of the LED lighting system.

In essence, compare block 34 controls light via LED driver so the color components of the generated light are calibrated with color components represented by the selected RGB calibration entry. As long as the proportions (ratio) of red, green and blue of the generated light is the same as the ratio of color components represented by the selected RGB calibration entry, then it is determined that the same hue is obtained.

Since the brightness of white light source 23 may be different from the brightness of light generated by each of LEDs 31, 32 and 33 system, it is possible that light generated by LEDs 31, 32 and 33 will not have the same brightness as the light generated by white light source 23, even though the same hue has been achieved.

Input signal 21 may be used to scale the ratio of the stored values for the selected RGB calibration entry. For example, if the stored values for the selected RGB calibration entry has an R:G:B ratio of 3:6:1, a scale of two placed on input 21 increases the stored values for the selected RGB calibration entry so that the stored R:G:B values are increased to 6:12:2. Since the proportions of the color components are the same, the same hue is obtained, but the light generated by LEDs 31, 32 and 33 will have a brightness level that is two times higher than the light represented by the selected RGB calibration entry. In the event that the light generated by white light source 23 has the same brightness level as the light generated by LEDs 31, 32 and 33, then a scale of value of one is placed on input 21 and no scaling is performed. LEDs 31, 32 and 33 will then produce the same level of brightness as white light source 23 as well as the same hue. In other words, the same color (i.e., hue and brightness) is matched.

While the invention has been illustrated using an RGB color scheme, other color schemes can be used as well. For example, a six-color system could be used where the six colors are red, blue, green, cyan, magenta and yellow. Alternatively, other schemes could be used. Also, while in the described embodiment, there is an approximate correspondence between the colors generated by LEDs 31 through 33 and the colors detected by photosensors 16 through 18, this is not necessary for the invention to operate properly. As will be understood by a person of ordinary skill in the art, the color scheme used to generate the light can be different than the color scheme used to detect the light. Since the calibration entries (or calibration entries using any color scheme) need not be converted to any known colorimetric standards the calibration entries can be stored, manipulated and used in an arbitrary colorimetric system.

The signal of the photosensor can be any physically known signal such as voltage or frequency and can be either analog or digital. Depending on the nature of the signal, converter 36 is suitably configured to process the signal.

The invention can be advantageously used together with an optical light guide as backlighting for a display, for example, a liquid crystal display (LCD). Alternatively the invention can be used as backlighting for automotive interior display and automotive interior lighting. Further, when coupled with lenses and/or reflectors and/or diffusers, the inventions can be used in areas of indoor and outdoor illumination.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A method for calibrating and operating a light source comprising:
performing the following during calibration of the light source:
providing calibration light from a calibration light source,
detecting the calibration light, and
storing a representation of the detected calibration light; and,
performing the following during operation of the light source:
generating light by the light source,
detecting the light generated by the light source, and
comparing the light generated by the light source with the stored representation of the detected calibration light to generate information used to control color of the light generated by the light source.

2. A method as in claim 1 wherein the calibration light is a color that is a color temperature of white.

3. A method as in claim 1:
wherein detecting the calibration light comprises detecting color components of the calibration light;
wherein storing the representation of the detected calibration light comprises storing representations of the color components of the calibration light; and,
wherein comparing the light generated by the light source with the stored representations of the detected calibration light comprises comparing color components of the light generated by the light source with the stored representations of the detected color components of the calibration light.

4. A method as in claim 1 wherein the light source is implemented using a red light emitting diode, a green light emitting diode and a blue light emitting diode.

5. A method for calibrating a light source comprising:
providing first calibration light of a first color from a calibration light source;
detecting the first calibration light;
storing a representation of the detected first calibration light;
providing second calibration light of a second color;
detecting the second calibration light; and,
storing a representation of the detected second calibration light.

6. A method as in claim 5 wherein the first calibration light and the second calibration light are each white light of different color temperatures.

7. A method as in claim 5 wherein the light source is implemented using a plurality of different color light emitting diodes.

8. A method as in claim 5:
wherein detecting the first calibration light comprises detecting color components of the first calibration light;
wherein storing the representation of the first calibration light comprises storing the color components of the first calibration light;
wherein detecting the second calibration light comprises detecting color components of the second calibration light; and,
wherein storing the representation of the second calibration light comprises storing the color components of the second calibration light.

9. A lighting system comprising:
a light source;
a light detector;
a memory used to store a representation of calibration light detected by the light detector, the calibration light being provided from a calibration light source; and,
a comparator block that compares light generated by the light source and detected by the light detector with the stored representation of the calibration light to provide information to the light source.

10. A lighting system as in claim 9 wherein the light source is at least one of the following:
backlighting for a display;
backlighting for automotive interior display;
automotive interior lighting;
indoor illumination;
outdoor illumination.

11. A lighting system as in claim 9 wherein the calibration light is a color that is a color temperature of white.

12. A lighting system as in claim 9 wherein the light source is implemented using a plurality of different color light emitting diodes.

13. A lighting system as in claim 9 wherein the light source is implemented using a red light emitting diode, a green light emitting diode and a blue light emitting diode.

14. A lighting system as in claim 9:
wherein the stored representation of calibration light comprises color components of the calibration light; and
wherein the comparator block compares color components of the light generated by the light source and detected by the light detector with the stored representations of the color components of the calibration light to provide information to the light source.

15. A lighting system as in claim 14 wherein the memory stores a plurality of entries, each entry including color components for a different color calibration light detected by the light detector.

16. A lighting system as in claim 15 wherein the memory and the comparator block are within a controller, the controller including a selection input that allows a user to select one of the entries stored in the memory to be used by the comparator block to generate the information.

17. A lighting system as in claim 14 wherein the light detector includes a plurality of photosensors, one photosensor being used for reach color component detected by the light detector.

18. A lighting system as in claim 14:
wherein the light detector includes a plurality of photosensors, one photosensor being used for reach color component detected by the light detector; and,
wherein the color components are red, green and blue.

19. A lighting system as in claim 14 additionally comprising:
a converter that converts the color components detected by the light detector in the representations of the color components stored in the memory.

20. A lighting system as in claim 19 wherein the memory, the converter and the comparator block are within a controller.
